(19) United States
(12) Patent Application Publication
(10) Pub. No.: US 2015/0020979 A1
(43) Pub. Date: Jan. 22, 2015

(54) PEELING APPARATUS AND PEELING METHOD

(71) Applicant: DISCO CORPORATION, Tokyo (JP)

(72) Inventor: Nobuhide Maeda, Tokyo (JP)

(21) Appl. No.: 14/333,267

(22) Filed: Jul. 16, 2014

(30) Foreign Application Priority Data
Jul. 18, 2013 (JP) 2013-149665

(51) Int. Cl. B32B 38/10

(52) U.S. Cl. CPC B32B 38/10
USPC 156/711; 156/752

(57) ABSTRACT

A peeling apparatus for peeling a device substrate from a stacked workpiece obtained by attaching the device substrate through a thermoplastic adhesive to a support substrate. The peeling apparatus includes a first surface plate having a first holding surface for holding the entire surface of the support substrate under suction and a first heating member for heating the first holding surface, a second surface plate having a second holding surface for holding the entire surface of the device substrate under suction and a second heating member for heating the second holding surface, and a moving unit for relatively moving the first surface plate and the second surface plate so that the first holding surface and the second holding surface are relatively moved away from each other in a direction perpendicular to the first holding surface and the second holding surface.

### BACKGROUND OF THE INVENTION

1. Field of the Invention

The present invention relates to a peeling apparatus and a peeling method of separating a support substrate from a device substrate in a device fabrication process.

2. Description of the Related Art

In a device fabrication process, a device substrate having devices formed thereon is processed in the condition where the device substrate is temporarily fixed through a thermoplastic adhesive to a hard support substrate such as a glass substrate. The device substrate processed is separated from the support substrate by a thermal sliding method. The thermal sliding method includes the steps of heating the thermoplastic adhesive to soften it and next relatively sliding the device substrate and the support substrate (see Japanese Patent Laid-open No. 2012-069740).

### SUMMARY OF THE INVENTION

However, in the case that the device substrate has a surface structure such as bumps projecting from the surface of the device substrate, there is a possibility that when the hard support substrate is separated from the device substrate by the thermal sliding method, the surface structure such as bumps formed on the device substrate may be damaged.

It is therefore an object of the present invention to provide a peeling apparatus and a peeling method which can separate the support substrate from the device substrate in the condition where damage to the surface structure of the device substrate is suppressed.

In accordance with an aspect of the present invention, there is provided a peeling apparatus for peeling a device substrate from a stacked workpiece obtained by attaching the device substrate through a thermoplastic adhesive to a support substrate, the peeling apparatus including: a first surface plate having a first holding surface for holding the entire surface of the support substrate under suction and a first heating member for heating the first holding surface; a second surface plate having a second holding surface for holding the entire surface of the device substrate under suction and a second heating member for heating the second holding surface, the first holding surface and the second holding surface being opposed to each other; and moving means for relatively moving the first surface plate and the second surface plate so that the first holding surface and the second holding surface are relatively moved away from each other in a direction perpendicular to the first holding surface and the second holding surface.

In accordance with another aspect of the present invention, there is provided a peeling method of peeling the device substrate from the stacked workpiece by using the peeling apparatus described above, the peeling method including: a holding step of holding the support substrate of the stacked workpiece on the first holding surface of the first surface plate under suction and holding the device substrate of the stacked workpiece on the second holding surface of the second surface plate; a heating step of heating the first holding surface and the second holding surface after performing the holding step until the viscosity of the thermoplastic adhesive is decreased to a predetermined viscosity or less and the thermoplastic adhesive is therefore softened; and a peeling step of operating the moving means after performing the heating step to relatively move the first surface plate and the second surface plate away from each other in the direction perpendicular to the first holding surface and the second holding surface, thereby vertically separating the device substrate and the support substrate from each other.

According to the peeling apparatus described above, the support substrate can be separated from the device substrate in the condition where damage to the surface structure of the device substrate is suppressed.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a schematic sectional view showing the configuration of a peeling apparatus according to a preferred embodiment of the present invention;

FIG. 2 is a sectional view of first and second surface plates included in the peeling apparatus shown in FIG. 1;

FIG. 3 is a plan view of each surface plate shown in FIG. 2;

FIG. 4 is a sectional view for illustrating a holding step and a heating step in a peeling method according to this preferred embodiment;

FIG. 5 is a graph showing a property of a thermoplastic adhesive; and

FIG. 6 is a sectional view for illustrating a peeling step in the peeling method.

### DETAILED DESCRIPTION OF THE PREFERRED EMBODIMENT

A peeling apparatus and a peeling method according to a preferred embodiment of the present invention will now be described in detail with reference to the drawings. The present invention is not limited to this preferred embodiment. Further, the components used in this preferred embodiment may include those that can be easily assumed by persons skilled in the art or substantially the same elements as those known in the art.

### Preferred Embodiment

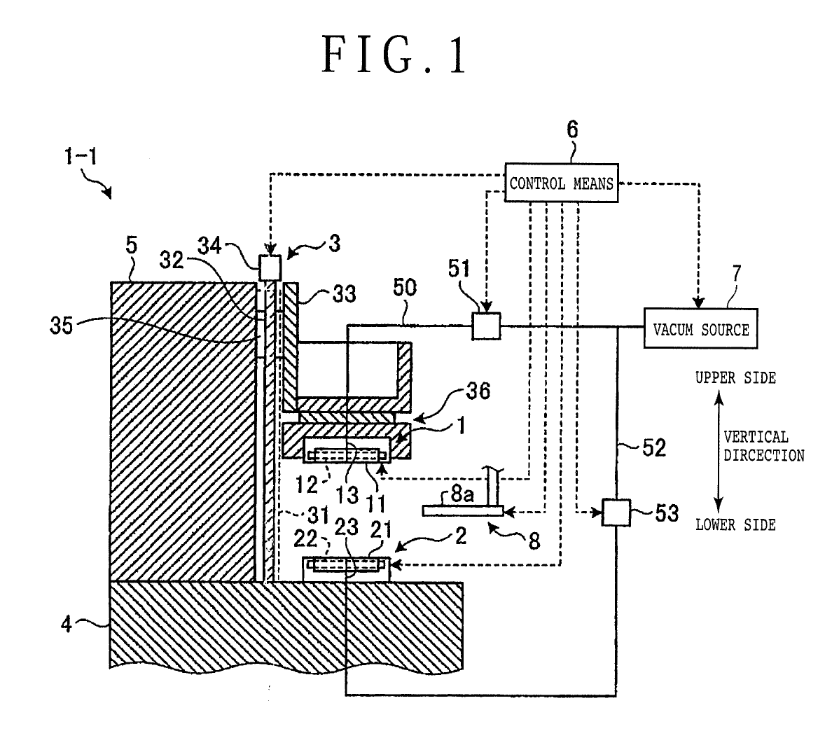

A preferred embodiment of the present invention will now be described with reference to FIGS. 1 to 6. FIG. 1 shows a peeling apparatus 1-1 according to this preferred embodiment. The peeling apparatus 1-1 essentially includes a first surface plate 1, a second surface plate 2, and moving means 3. The peeling apparatus 1-1 further includes a base 4, a column member 5, control means 6, a vacuum source 7, and transfer means 8.

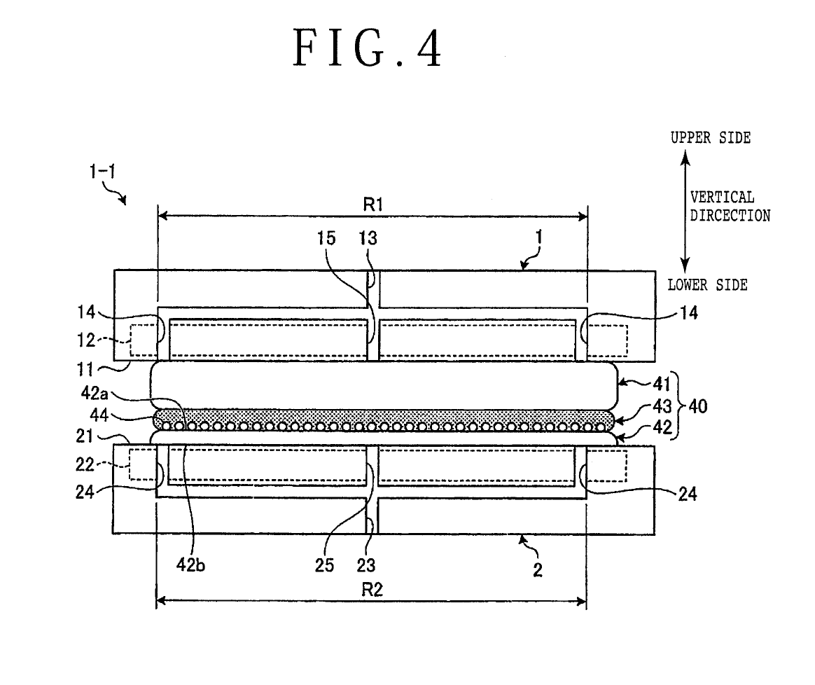

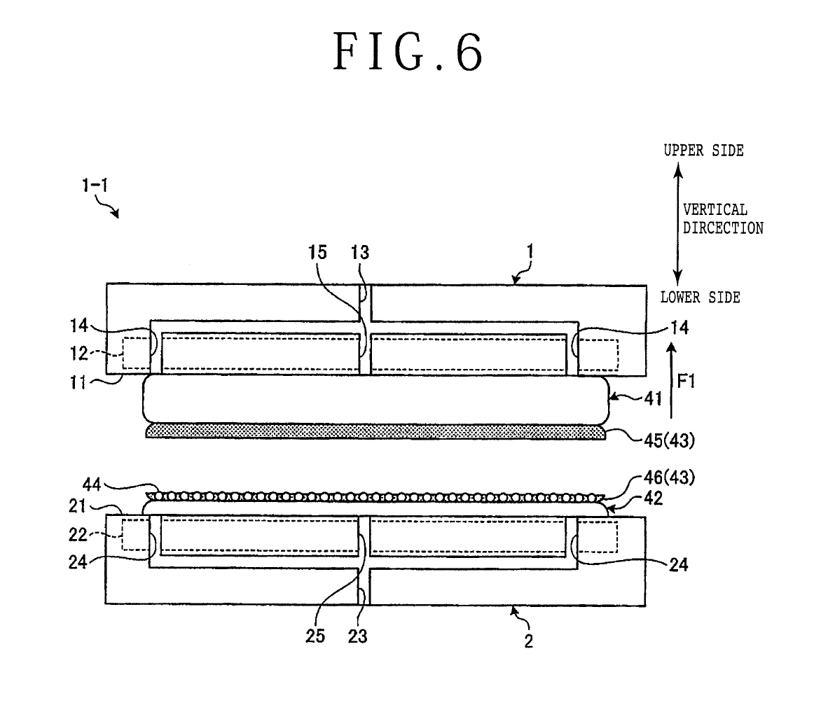

The general outlines of the peeling apparatus 1-1 and the peeling method according to this preferred embodiment will now be described with reference to FIGS. 4 and 6. As shown in FIG. 4, a support substrate 41 and a device substrate 42 constituting a stacked workpiece 40 are held under suction by the first surface plate 1 and the second surface plate 2, respectively, each of the first and second surface plates 1 and 2 incorporating a heater. Thereafter, the heaters in the first and second surface plates 1 and 2 are operated to soften a thermoplastic adhesive 43 interposed between the support substrate 41 and the device substrate 42 so that the viscosity of the thermoplastic adhesive 43 becomes a predetermined viscosity. Thereafter, the first and second surface plates 1 and 2 are relatively moved away from each other (in a direction shown by an arrow F1 in FIG. 6), thereby vertically separating the support substrate 41 and the device substrate 42 from each other. Accordingly, as compared with the conventional slide peeling method, the support substrate 41 can be separated from the device substrate 42 in a short time without causing damage to the surface structure of the device substrate 42.

As shown in FIG. 1, the base 4 is a body member for supporting the second surface plate 2, the moving means 3, and the column member 5. The column member 5 is a vertically elongated member fixed to the base 4. The moving means 3 functions to relatively move the first surface plate 1 and the second surface plate 2 so that a first holding surface 11 of the first surface plate 1 and a second holding surface 21 of the second surface plate 2 are moved away from each other in a direction perpendicular to the first and second holding surfaces 11 and 21. In the peeling apparatus 1-1, the first holding surface 11 and the second holding surface 21 are opposed to each other in the vertical direction. Accordingly, the moving means 3 functions to relatively move the first surface plate 1 and the second surface plate 2 away from each other in the vertical direction. More specifically, the moving means 3 is adapted to move the first surface plate 1 relative to the base 4 in the vertical direction. Accordingly, the moving means 3 operates to move the first surface plate 1 relative to the second surface plate 2 in the vertical direction, thereby moving the first surface plate 1 away from or toward the second surface plate 2.

The moving means 3 has a guide rail 31, a ball screw 32, a table 33, and a motor 34. The guide rail 31 extends in the vertical direction and functions to guide the table 33 in the vertical direction. The ball screw 32 extends in the vertical direction and is rotatable about a vertical axis. The table 33 has a nut portion 35 through which a screw portion of the ball screw 32 is inserted. The motor 34 is a rotary motor for rotating the ball screw 32. The rotation of the ball screw 32 is converted into linear motion in the vertical direction in the nut portion 35. The table 33 is moved upward or downward in the vertical direction according to the rotational direction of the ball screw 32.

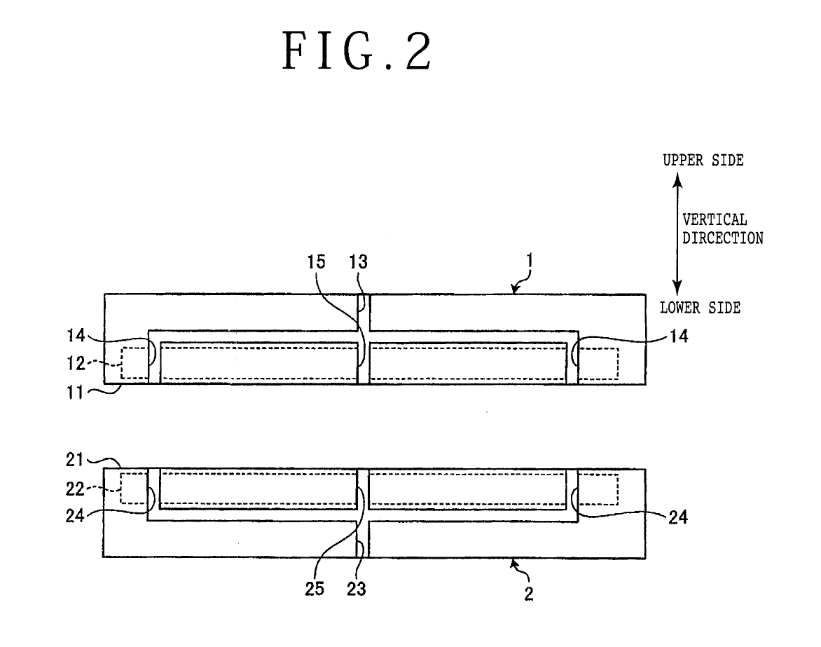

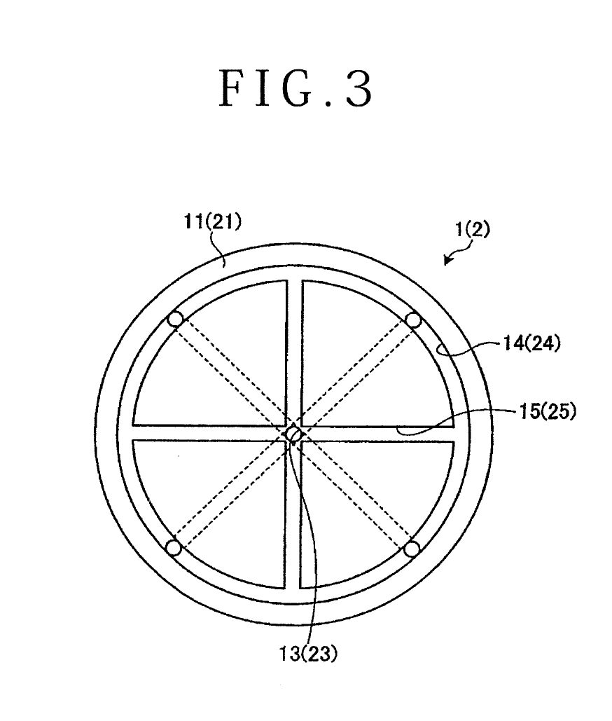

A support member 36 is fixed to the table 33. The first surface plate 1 is supported by the support member 36. More specifically, the first surface plate 1 is supported to the lower surface of the support member 36. The second surface plate 2 is fixed to the base 4. The first surface plate 1 and the second surface plate 2 are opposed to each other in the vertical direction and arranged coaxially. As shown in FIG. 2, the first surface plate 1 and the second surface plate 2 are platelike members. As shown in FIG. 3, each of the first surface plate 1 and the second surface plate 2 has a circular shape. As shown in FIG. 2, the outer diameter of the first surface plate 1 is equal to the outer diameter of the second surface plate 2. Further, the thickness of the first surface plate 1 is equal to the thickness of the second surface plate 2.

The first surface plate 1 includes the first holding surface 11 and a first heating member 12. The first surface plate 1 further has a suction hole 13. The suction hole 13 opens to another surface of the first surface plate 1 opposite to the first holding surface 11. The first holding surface 11 is a surface oriented downward in the vertical direction. The first heating member 12 functions to heat the first holding surface 11. For example, the first heating member 12 is a heater capable of converting electrical energy supplied into heat energy. The first heating member 12 is built in the first surface plate 1 near the first holding surface 11. The outer shape of the first heating member 12 is circular.

The suction hole 13 is in communication with an outer circumferential groove 14 and an inner radial groove 15. As shown in FIG. 3, the outer circumferential groove 14 is an annular groove formed in an outer circumferential portion of the first holding surface 11. The inner radial groove 15 is a groove formed inside the outer circumferential groove 14 so as to extend in the radial direction of the first holding surface 11. In this preferred embodiment, the inner radial groove 15 is formed as a cross-shaped groove composed of two perpendicular grooves formed on the first holding surface 11. The outer circumferential groove 14 and the inner radial groove 15 are in communication with each other.

Referring back to FIG. 2, the second surface plate 2 includes the second holding surface 21 and a second heating member 22. The second surface plate 2 further has a suction hole 23. The suction hole 23 opens to another surface of the second surface plate 2 opposite to the second holding surface 21. The second holding surface 21 is a surface oriented upward in the vertical direction. The second heating member 22 functions to heat the second holding surface 21. For example, the second heating member 22 is a heater capable of converting electrical energy supplied into heat energy. The second heating member 22 is built in the second surface plate 2 near the second holding surface 21. The outer shape of the second heating member 22 is circular.

The suction hole 23 is in communication with an outer circumferential groove 24 and an inner radial groove 25. The outer circumferential groove 24 and the inner radial groove 25 are formed on the second holding surface 21. For example, the shapes of the outer circumferential groove 24 and the inner radial groove 25 may be similar to the shapes of the outer circumferential groove 14 and the inner radial groove 15 shown in FIG. 3.

The first surface plate 1 is located on the upper side of the second surface plate 2 in the vertical direction. That is, the first holding surface 11 of the first surface plate 1 is opposed to the second holding surface 21 of the second surface plate 2 in the vertical direction. As shown in FIG. 4, the first holding surface 11 of the first surface plate 1 functions to hold the entire surface of the support substrate 41 of the stacked workpiece 40. The stacked workpiece 40 is a platelike workpiece formed by stacking the device substrate 42, the thermoplastic adhesive 43, and the support substrate 41.

The device substrate 42 is a substrate on which a plurality of devices such as semiconductor devices and optical devices are formed. In this preferred embodiment, the device substrate 42 is a circular substrate. A plurality of bumps 44 are arranged on the front side 42a of the device substrate 42. Each bump 44 has such a shape as to project from the front side 42a of the device substrate 42. The support substrate 41 is attached through the thermoplastic adhesive 43 to the front side 42a of the device substrate 42. The thickness of the layer of the thermoplastic adhesive 43 is larger than the height of each bump 44. Accordingly, each bump 44 is embedded in the layer of the thermoplastic adhesive 43.

The support substrate 41 is a substrate formed of a hard material such as glass. In this preferred embodiment, the support substrate 41 is a circular substrate. The support substrate 41 has a function of supporting the device substrate 42 to suppress the deformation of the device substrate 42 and also has a function of facilitating the transfer of the device substrate 42. For example, the back side 42b of the device substrate 42 supported by the support substrate 41 is ground by a grinding apparatus. FIG. 4 shows the stacked workpiece 40 in the condition after the device substrate 42 is ground.

The peeling apparatus 1-1 according to this preferred embodiment is an apparatus for peeling the device substrate 42 from the stacked workpiece 40 formed by attaching the device substrate 42 through the thermoplastic adhesive 43 to the support substrate 41. In this preferred embodiment, the peeling apparatus 1-1 functions to separate the device substrate 42 processed by grinding from the support substrate 41.

As shown in FIG. 1, the suction hole 13 of the first surface plate 1 and the suction hole 23 of the second surface plate 2 are connected to the vacuum source 7. An on-off valve 51 is provided in a passage 50 for connecting the suction hole 13 of the first surface plate 1 and the vacuum source 7. The on-off valve 51 is a control valve for opening or closing the passage 50. Similarly, an on-off valve 53 is provided in a passage 52 for connecting the suction hole 23 of the second surface plate 2 and the vacuum source 7. The on-off valve 53 is a control valve for opening or closing the passage 52.

The transfer means 8 functions to transfer the stacked workpiece 40 or the device substrate 42. The transfer means 8 can transfer the stacked workpiece 40 to the second holding surface 21 and can also transfer the device substrate 42 from the second holding surface 21. The transfer means 8 has a holding member 8a. For example, the holding member 8a has a function of holding the stacked workpiece 40 or the device substrate 42 under suction.

The control means 6 is a control unit having a computer and has a function of controlling the whole of the peeling apparatus 1-1. More specifically, the control means 6 has a function of controlling the motor 34 of the moving means 3, a function of controlling the vacuum source 7, a function of controlling the on-off valve 51, and a function of controlling the on-off valve 53. The control means 6 further has a function of controlling the first heating member 12 and a function of controlling the second heating member 22. The control means 6 further has a function of controlling the transfer means 8.

Referring back to FIG. 4, the first holding surface 11 is adapted to hold the entire surface of the support substrate 41. In this preferred embodiment, the outer diameter of the first holding surface 11 is substantially equal to the outer diameter of the support substrate 41. More specifically, the outer diameter of the first holding surface 11 is slightly larger than the outer diameter of the support substrate 41. Accordingly, the first holding surface 11 can cover the whole of the upper surface of the support substrate 41. Further, the outermost diameter R1 of the outer circumferential groove 14 is slightly smaller than the outer diameter of the support substrate 41. Accordingly, when a vacuum is supplied from the vacuum source 7 to the outer circumferential groove 14, this vacuum operates to suck the outer circumferential portion of the upper surface of the support substrate 41 against the first holding surface 11. Further, when a vacuum is supplied from the vacuum source 7 to the inner radial groove 15, this vacuum operates to suck the central portion of the upper surface of the support substrate 41 against the first holding surface 11. In this manner, the first holding surface 11 can hold the whole of the upper surface of the support substrate 41 by using the vacuum supplied to the outer circumferential groove 14 and the inner radial groove 15.

The outer diameter of the first heating member 12 is substantially equal to the outer diameter of the support substrate 41. More specifically, the outer diameter of the first heating member 12 is slightly larger than the outer diameter of the support substrate 41. Accordingly, the first heating member 12 can heat the entire surface of the support substrate 41. For example, the first heating member 12 can uniformly heat the entire surface of the support substrate 41.

The second holding surface 21 is adapted to hold the entire surface of the device substrate 42. In this preferred embodiment, the outer diameter of the second holding surface 21 is substantially equal to the outer diameter of the device substrate 42. More specifically, the outer diameter of the second holding surface 21 is slightly larger than the outer diameter of the device substrate 42. Accordingly, the second holding surface 21 can cover the whole of the lower surface of the device substrate 42. Further, the outermost diameter R2 of the outer circumferential groove 24 is slightly smaller than the outer diameter of the device substrate 42. Accordingly, when a vacuum is supplied from the vacuum source 7 to the outer circumferential groove 24, this vacuum operates to suck the outer circumferential portion of the lower surface of the device substrate 42 against the second holding surface 21. Further, when a vacuum is supplied from the vacuum source 7 to the inner radial groove 25, this vacuum operates to suck the central portion of the lower surface of the device substrate 42 against the second holding surface 21. In this manner, the second holding surface 21 can hold the whole of the lower surface of the device substrate 42 by using the vacuum supplied to the outer circumferential groove 24 and the inner radial groove 25.

The outer diameter of the second heating member 22 is substantially equal to the outer diameter of the device substrate 42. More specifically, the outer diameter of the second heating member 22 is slightly larger than the outer diameter of the device substrate 42. Accordingly, the second heating member 22 can heat the entire surface of the device substrate 42. For example, the second heating member 22 can uniformly heat the entire surface of the device substrate 42.

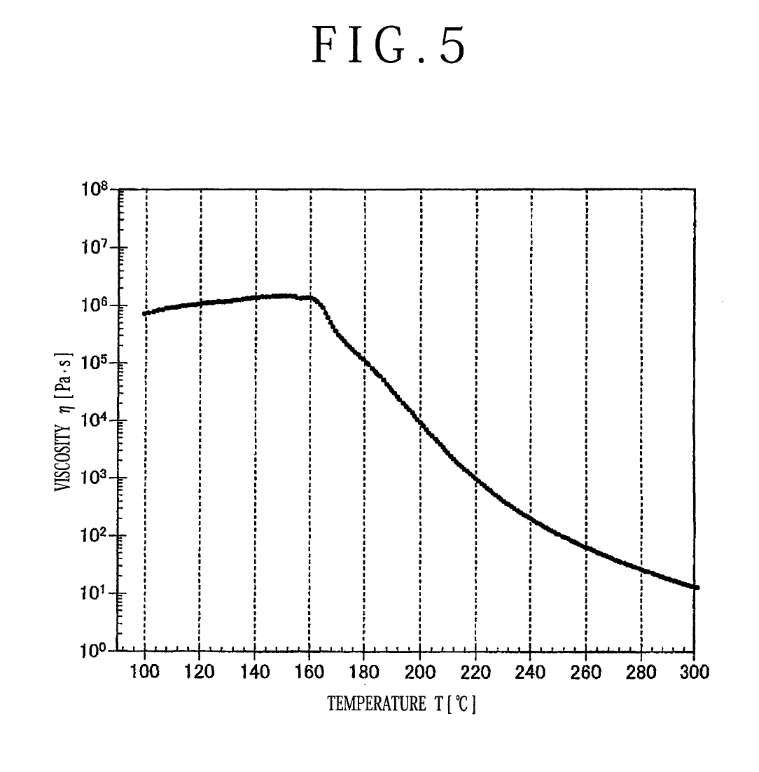

When the first holding surface 11 is heated by the first heating member 12, the heat is transferred through the support substrate 41 to the thermoplastic adhesive 43. Similarly, when the second holding surface 21 is heated by the second heating member 22, the heat is transferred through the device substrate 42 to the thermoplastic adhesive 43. Accordingly, the thermoplastic adhesive 43 is heated and its temperature rises. As described later with reference to FIG. 5, the thermoplastic adhesive 43 has a property such that its viscosity decreases with an increase in temperature.

In FIG. 5, the horizontal axis represents temperature T [° C.], and the vertical axis represents the viscosity η [Pa·s] of the thermoplastic adhesive 43 corresponding to temperature T. As shown in FIG. 5, the viscosity of the thermoplastic adhesive 43 starts to decrease when the temperature exceeds about 160° C., and continues to decrease with an increase in temperature.

In the peeling apparatus 1-1 according to this preferred embodiment, the thermoplastic adhesive 43 is heated by the first heating member 12 and the second heating member 22. When the viscosity of the thermoplastic adhesive 43 is decreased to a predetermined viscosity or less and the thermoplastic adhesive 43 is therefore softened by this heating, the device substrate 42 is peeled from the stacked workpiece 40. In this preferred embodiment, this predetermined viscosity is set to 1000 [Pa·s]. When the viscosity η of the thermoplastic adhesive 43 is decreased to this predetermined viscosity, the thermoplastic adhesive 43 is softened moderately, so that the support substrate 41 and the device substrate 42 can be separated from each other. Further, since the thermoplastic adhesive 43 is softened moderately, it is possible to suppress damage to the bumps 44 in separating the support substrate 41 and the device substrate 42 from each other.

When the viscosity η of the thermoplastic adhesive 43 is decreased to the predetermined viscosity or less, the moving means 3 in the peeling apparatus 1-1 is operated to raise the first surface plate 1 in the vertical direction. Accordingly, the first surface plate 1 is moved relative to the second surface plate 2 so that the first holding surface 11 and the second holding surface 21 are moved away from each other in the direction perpendicular to the first and second holding surfaces 11 and 21. The moving means 3 generates a drive force having a direction of moving the first surface plate 1 away from the second surface plate 2, so that a force of separating the support substrate 41 from the device substrate 42 acts on the support substrate 41 (see the arrow F1 shown in FIG. 6). Accordingly, the layer of the thermoplastic adhesive 43 is separated into a portion 45 adhering to the support substrate 41 and a portion 46 adhering to the device substrate 42. That is, the device substrate 42 is peeled from the stacked workpiece 40. The support substrate 41 and the portion 45 of the thermoplastic adhesive 43 adhering to the support substrate 41 are held on the first holding surface 11 under suction and moved upward with the first surface plate 1. On the other hand, the device substrate 42 and the portion 46 of the thermoplastic adhesive 43 adhering to the device substrate 42 are held on the second holding surface 21 under suction and left on the second surface plate 2.

As described above, the peeling apparatus 1-1 according to this preferred embodiment can separate the stacked workpiece 40 into the support substrate 41 and the device substrate 42 in the vertical direction. Further, the peeling apparatus 1-1 can heat the thermoplastic adhesive 43 to decrease its viscosity η, thereby moderately softening the thermoplastic adhesive 43. Thereafter, the first surface plate 1 is moved upward to thereby separate the support substrate 41 from the device substrate 42 in the condition where damage to the surface structure such as the bumps 44 on the device substrate 42 can be suppressed.

The peeling method according to this preferred embodiment will now be described. The peeling method according to this preferred embodiment is a peeling method of peeling the device substrate 42 from the stacked workpiece 40 by using the peeling apparatus 1-1 described above. The peeling method according to this preferred embodiment includes a holding step, a heating step, and a peeling step.

### (Holding Step)

The holding step is a step of holding the support substrate 41 of the stacked workpiece 40 on the first holding surface 11 of the first surface plate 1 under suction and also holding the device substrate 42 of the stacked workpiece 40 on the second holding surface 21 of the second surface plate 2 under suction. In the holding step, the control means 6 controls the transfer means 8 to transfer the stacked workpiece 40 to the second surface plate 2 and place the stacked workpiece 40 on the second holding surface 21. Prior to placing the stacked workpiece 40 on the second holding surface 21, the first surface plate 1 is preliminarily raised to a retracted position by the moving means 3. In the case that the first surface plate 1 is in the retracted position, a sufficient space is allowed between the first holding surface 11 and the second holding surface 21. Accordingly, the transfer means 8 can be moved into this space to place the stacked workpiece 40 on the second holding surface 21. The transfer means 8 is controlled to place the stacked workpiece 40 so that the outer circumferential groove 24 of the second holding surface 21 is closed by the device substrate 42.

After placing the stacked workpiece 40 on the second holding surface 21, the control means 6 opens the on-off valve 53. As a result, a vacuum is supplied from the vacuum source 7 to the outer circumferential groove 24 and the inner radial groove 25 of the second holding surface 21, so that the device substrate 42 is held on the second holding surface 21 under suction. Further, after placing the stacked workpiece 40 on the second holding surface 21, the control means 6 controls the moving means 3 to lower the first surface plate 1. When the first surface plate 1 is lowered to a position where the first holding surface 11 comes into contact with the support substrate 41, the moving means 3 is stopped by the control means 6. When the first holding surface 11 comes into contact with the support substrate 41, the control means 6 opens the on-off valve 51. As a result, a vacuum is supplied from the vacuum source 7 to the outer circumferential groove 14 and the inner radial groove 15 of the first holding surface 11, so that the support substrate 41 is held on the first holding surface 11 under suction.

In this manner, the support substrate 41 is held on the first holding surface 11 under suction and the device substrate 42 is held on the second holding surface 21 under suction, thus ending the holding step. In the condition where the holding step is ended, the stacked workpiece 40 is sandwiched between the first holding surface 11 and the second holding surface 21 as shown in FIG. 4.

### (Heating Step)

The heating step is performed after performing the holding step described above. In the heating step, the peeling apparatus 1-1 operates to heat the first holding surface 11 and the second holding surface 21 until the viscosity of the thermoplastic adhesive 43 is decreased to a predetermined viscosity or less and the thermoplastic adhesive 43 is therefore softened. The heating step is performed in the condition where the support substrate 41 is held on the first holding surface 11 under suction and the device substrate 42 is held on the second holding surface 21 under suction as shown in FIG. 4. The control means 6 outputs a heating command to the first heating member 12 to heat the first holding surface 11 through the first heating member 12. Similarly, the control means 6 outputs a heating command to the second heating member 22 to heat the second holding surface 21 through the second heating member 22. When the viscosity η of the thermoplastic adhesive 43 is decreased to a predetermined viscosity or less by this heating, the control means 6 controls the first and second heating members 12 and 22 to end the heating step.

More specifically, the control means 6 ends the heating step according to the temperature of the thermoplastic adhesive 43. As shown in FIG. 5, the viscosity η of the thermoplastic adhesive 43 decreases with an increase in temperature T in a certain temperature range higher than or equal to a given temperature. Accordingly, the viscosity η of the thermoplastic adhesive 43 can be estimated according to its temperature T. The control means 6 may directly detect the temperature T of the thermoplastic adhesive 43 or may estimate the temperature T of the thermoplastic adhesive 43 according to the temperature of the first holding surface 11 or the temperature of the second holding surface 21. As a modification, the temperature T of the thermoplastic adhesive 43 may be estimated according to the temperature of any other parts or heating time, for example.

As apparent from FIG. 5, the viscosity η of the thermoplastic adhesive 43 becomes 1000 [Pa·s] or less in a temperature range higher than or equal to about 230° C. as the temperature T of the thermoplastic adhesive 43. Accordingly, when the detected value or estimated value for the temperature T of the thermoplastic adhesive 43 becomes 230° C. or higher, the control means 6 ends the heating step.

### (Peeling Step)

The peeling step is performed after performing the heating step described above. The peeling step is a step of operating the moving means 3 to relatively move the first surface plate 1 and the second surface plate 2 away from each other in a direction perpendicular to the first holding surface 11 and the second holding surface 21, thereby vertically separating the device substrate 42 and the support substrate 41 from each other.

More specifically, the control means 6 controls the moving means 3 to raise the first surface plate 1. That is, the control means 6 controls the moving means 3 to apply a force to the first surface plate 1 and the second surface plate 2 in vertically opposite directions. Accordingly, the first surface plate 1 and the second surface plate 2 are moved away from each other in a direction perpendicular to the first holding surface 11 and the second holding surface 21. As a result, the layer of the thermoplastic adhesive 43 is separated into the portion 45 adhering to the support substrate 41 and the portion 46 adhering to the device substrate 42 as shown in FIG. 6.

In the peeling step, heating by the first heating member 12 and the second heating member 22 may be continued. Further, the output torque of the motor 34 may be variably controlled in the peeling step. For example, the output torque of the motor 34 may be gradually increased in the peeling step. Further, the upper limit of the output torque of the motor 34 may be set in the peeling step. For example, the output torque of the motor 34 may be limited according to the strength, etc. of the surface structure such as the bumps 44 provided on the device substrate 42. Further, the rotational speed of the motor 34 may be variably controlled in the peeling step. For example, the rotational speed of the motor 34 may be gradually increased in the peeling step.

When the support substrate 41 and the device substrate 42 are separated from each other as described above, the control means 6 ends the peeling step. For example, when the distance between the first holding surface 11 and the second holding surface 21 in the vertical direction becomes a predetermined distance or more, the control means 6 ends the peeling step. As a modification, when the load on the motor 34 becomes a predetermined load or less, the control means 6 may end the peeling step. As another modification, the control means 6 may end the peeling step according to the result of analysis of image data produced by imaging the stacked workpiece 40.

After ending the peeling step, the control means 6 controls the transfer means 8 to transfer the device substrate 42 from the second holding surface 21. The device substrate 42 transferred from the second holding surface 21 is stored into a cassette (not shown) for storing the device substrate 42, for example. Prior to transferring the device substrate 42 from the second holding surface 21, the on-off valve 53 is closed by the control means 6 to stop the suction holding to the device substrate 42.

After transferring the device substrate 42 from the second holding surface 21, the control means 6 controls the moving means 3 to lower the first surface plate 1 and place the support substrate 41 on the second holding surface 21. First, the control means 6 controls the moving means 3 to lower the support substrate 41 to a position near the second holding surface 21. For example, the moving means 3 lowers the first surface plate 1 to a position where the support substrate 41 comes into contact with the second holding surface 21. Thereafter, the on-off valve 51 is closed by the control means 6 to stop the suction holding to the support substrate 41. Thereafter, the control means 6 controls the moving means 3 to raise the first surface plate 1, so that the support substrate 41 is placed on the second holding surface 21. The first surface plate 1 is raised to the retracted position, and the support substrate 41 is next transferred from the second holding surface 21 by the transfer means 8. The support substrate 41 transferred from the second holding surface 21 is stored into a cassette (not shown) for storing the support substrate 41, for example.

As described above, the peeling apparatus 1-1 according to this preferred embodiment operates to relatively move the first surface plate 1 and the second surface plate 2 in a direction perpendicular to the first holding surface 11 and the second holding surface 21, thereby vertically separating the device substrate 42 and the support substrate 41 from each other. According to such a method of vertically separating the device substrate 42 and the support substrate 41 from each other, the following advantages can be obtained.

In the case of relatively sliding the device substrate 42 and the support substrate 41 in a direction parallel to the first holding surface 11 and the second holding surface 21 to thereby separate the device substrate 42 and the support substrate 41 from each other, a shearing force continues to act on the surface structure such as the bumps 44. Accordingly, in this case, it is considered that the surface structure of the device substrate 42 is prone to damage. To the contrary, according to the peeling apparatus 1-1 and the peeling method in this preferred embodiment, the device substrate 42 and the support substrate 41 are vertically separated from each other, thereby suppressing the action of a shearing force to the surface structure. Accordingly, it is possible to suppress damage to the surface structure due to a shearing force in separating the device substrate 42 and the support substrate 41 from each other.

The present inventor conducted an experiment on the peeling method according to this preferred embodiment by using a device substrate 42 having a diameter of 300 mm. It was confirmed from this experiment that when the viscosity η of the thermoplastic adhesive 43 is 1000 [Pa·s] or less in vertically separating the device substrate 42 and the support substrate 41 from each other, the support substrate 41 can be vertically separated from the device substrate 42 without damage to the surface structure of the device substrate 42.

Further, in the method of relatively sliding the device substrate 42 and the support substrate 41 to separate them from each other, the amount of relative movement of the device substrate 42 and the support substrate 41 is large. For example, the device substrate 42 and the support substrate 41 must be relatively moved a distance corresponding to the diameter of the device substrate 42 or the support substrate 41 in separating the device substrate 42 and the support substrate 41 from each other. To the contrary, according to the peeling apparatus 1-1 and the peeling method in this preferred embodiment, the device substrate 42 and the support substrate 41 can be separated from each other by relatively moving the device substrate 42 and the support substrate 41 by a small distance in the vertical direction. Accordingly, it is possible to reduce a required time from the start of relative movement of the device substrate 42 and the support substrate 41 to the end of separation of the device substrate 42 and the support substrate 41.

Further, in the method of relatively sliding the device substrate 42 and the support substrate 41 to separate them from each other, a large horizontal space is required to separate the device substrate 42 and the support substrate 41 from each other. To the contrary, according to the peeling apparatus 1-1 and the peeling method in this preferred embodiment, such a required space in the horizontal direction can be reduced.

### (First Modification of the Preferred Embodiment)

A first modification of the preferred embodiment will now be described. The moving means 3 is not limited to the configuration described above. For example, while the second surface plate 2 is fixed to the base 4 and the first surface plate 1 is vertically moved relative to the base 4 in the above preferred embodiment, the first surface plate 1 may be fixed and the second surface plate 2 may be moved relative to the base 4. Further, both the first surface plate 1 and the second surface plate 2 may be moved relative to the base 4. Further, the actuator in the moving means 3 is not limited to the motor 34 and the ball screw mechanism, but any suitable actuator may be used according to a force required for peeling, for example.

Further, while the first holding surface 11 and the second holding surface 21 are opposed to each other in the vertical direction in the above preferred embodiment, the direction of opposition is not limited. That is, the first holding surface 11 and the second holding surface 21 may be opposed to each other in any direction.

### (Second Modification of the Preferred Embodiment)

While the configuration for holding the support substrate 41 on the first holding surface 11 under suction is provided by the grooves 14 and 15 in the above preferred embodiment, the first holding surface 11 may have a plane holding area formed of a porous material such as porous ceramic in place of or in addition to the grooves 14 and 15. Similarly, the second holding surface 21 may have a plane holding area formed of a porous material in place of or in addition to the grooves 24 and 25.

### (Third Modification of the Preferred Embodiment)

While the outer diameter of the first holding surface 11 is greater than or equal to the outer diameter of the support substrate 41, and the outer diameter of the second holding surface 21 is greater than or equal to the outer diameter of the device substrate 42 in the above preferred embodiment, the configuration is not limited. For example, the outer diameter of the first holding surface 11 may be less than the outer diameter of the support substrate 41. Alternatively, the outer diameter of the second holding surface 21 may be less than the outer diameter of the device substrate 42. Further, the configurations described above in the preferred embodiment and its modifications may be suitably combined.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A peeling apparatus for peeling a device substrate from a stacked workpiece obtained by attaching said device substrate through a thermoplastic adhesive to a support substrate, said peeling apparatus comprising:
a first surface plate having a first holding surface for holding the entire surface of said support substrate under suction and a first heating member for heating said first holding surface;
a second surface plate having a second holding surface for holding the entire surface of said device substrate under suction and a second heating member for heating said second holding surface, said first holding surface and said second holding surface being opposed to each other; and
moving means for relatively moving said first surface plate and said second surface plate so that said first holding surface and said second holding surface are relatively moved away from each other in a direction perpendicular to said first holding surface and said second holding surface.

2. A peeling method of peeling a device substrate from a stacked workpiece obtained by attaching said device substrate through a thermoplastic adhesive to a support substrate by using a peeling apparatus comprising:
a first surface plate having a first holding surface for holding the entire surface of said support substrate under suction and a first heating member for heating said first holding surface;
a second surface plate having a second holding surface for holding the entire surface of said device substrate under suction and a second heating member for heating said second holding surface, said first holding surface and said second holding surface being opposed to each other; and
moving means for relatively moving said first surface plate and said second surface plate so that said first holding surface and said second holding surface are relatively moved away from each other in a direction perpendicular to said first holding surface and said second holding surface, said peeling method comprising:
a holding step of holding said support substrate of said stacked workpiece on said first holding surface of said first surface plate under suction and holding said device substrate of said stacked workpiece on said second holding surface of said second surface plate;
a heating step of heating said first holding surface and said second holding surface after performing said holding step until the viscosity of said thermoplastic adhesive is decreased to a predetermined viscosity or less and said thermoplastic adhesive is therefore softened; and
a peeling step of operating said moving means after performing said heating step to relatively move said first surface plate and said second surface plate away from each other in the direction perpendicular to said first holding surface and said second holding surface, thereby vertically separating said device substrate and said support substrate from each other.
